(19) United States
(12) Patent Application Publication
(10) Pub. No.: US 2004/0267969 A1
(43) Pub. Date: Dec. 30, 2004

(54) IEEE 1394 function control apparatus and method of controlling multiple functions

(76) Inventor: Takayuki Uchida, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/834,086

(22) Filed: Apr. 29, 2004

(30) Foreign Application Priority Data
May 1, 2003 (JP) 2003-126414

(51) Int. Cl. G06F 3/00

(52) U.S. Cl. 710/1

(57) ABSTRACT

A function control apparatus is disclosed, which includes multiple function service units configured to operate in response to receipt of a signal from another apparatus via an IEEE 1394 bus, and a control service unit configured to identify one or more of the function service units to be activated, to activate the identified function service unit, and to stop the activated identified function service unit. According to the above arrangements, the function control apparatus does not activate a function service unit that is not to be activated.

### BACKGROUND OF THE INVENTION

1. Field of the Invention

The present invention generally relates to a function control apparatus that controls multiple functions of an apparatus connected to a high-speed serial bus network, a method of controlling multiple functions, and a computer program for performing the method, and more particularly, to an IEEE 1394 function management apparatus of an apparatus supporting multiple functions in compliance with IEEE Std. 1394-1995, IEEE Std. 1394a-2000, and Serial Bus Protocol 2 (SBP-2), wherein the IEEE 1394 function management apparatus selects one or more functions to be used from multiple functions and centrally manages the selected functions.

2. Description of the Related Art

In accordance with recent developments in data exchange techniques, electronic apparatuses can exchange data at high speed. The IEEE 1394 is an international standard of a high speed serial interface. The IEEE 1394 has two modes, an asynchronous mode and an isochronous mode. In the isochronous mode, bandwidth can be reserved in advance, and as a result, a certain communication speed can be ensured. Additional data can be exchanged using the remaining bandwidth although communication speed is lowered.

Japanese Laid-Open Patent Application No. 2001-339417 discloses an apparatus that can be connected to the IEEE 1394 bus without being recognized by other apparatuses that have been already connected.

Japanese Laid-Open Patent Application No. 2002-33786 discloses an information processing apparatus that can analyze an apparatus supporting multiple protocols easily and in a short time period.

If an apparatus such as a multifunction peripheral has multiple functions supporting a protocol (SBP-2, for example) of the IEEE 1394, a service (computer program) needs to be provided to each function.

However, if only one or more among the multiple functions need to be used, the apparatus still activates the remaining functions even though the remaining functions are not to be used. As a result, the apparatus wastes resources such as memory capacity and CPU processing time. Another problem is that, if one of the multiple functions fails, the apparatus cannot recover from the failure.

### SUMMARY OF THE INVENTION

Accordingly, it is a general object of the present invention to provide a novel and useful function control apparatus in which at least one of the above problems is eliminated.

Another and more specific object of the present invention is to provide a function control apparatus that centrally controls multiple functions provided thereto.

To achieve at least one of the above objects, a function control apparatus according to the present invention, includes:

a plurality of function service units configured to operate in response to receipt of a signal from another apparatus via an IEEE 1394 bus;

a control service unit configured to identify one or more of the function service units to be activated, to activate the identified function service unit, and to stop the activated identified function service unit.

The control service unit identifies one or more of the multiple function service units that are to be activated, and activates the identified function service unit. According to the above arrangements, the function control apparatus does not activate a function service unit that is not to be activated.

Other objects, features, and advantages of the present invention will become more apparent from the following detailed description when read in conjunction with the accompanying drawings.

### BRIEF DESCRIPTION OF THE DRAWINGS

FIG. 1 is a schematic diagram showing a system according to an embodiment;

FIG. 2 is a schematic diagram for explaining the relation between a control service and function services according to an embodiment;

FIG. 3 is a flowchart for explaining the operation of the control service according to an embodiment;

FIG. 4 is an exemplary control table according to an embodiment;

FIG. 5 is an exemplary function service state control table according to an embodiment; and

FIG. 6 is a state transition chart for explaining the operation of the function service according to an embodiment.

### DETAILED DESCRIPTION OF THE PREFERRED EMBODIMENTS

The preferred embodiments of the present invention are described in detail below.

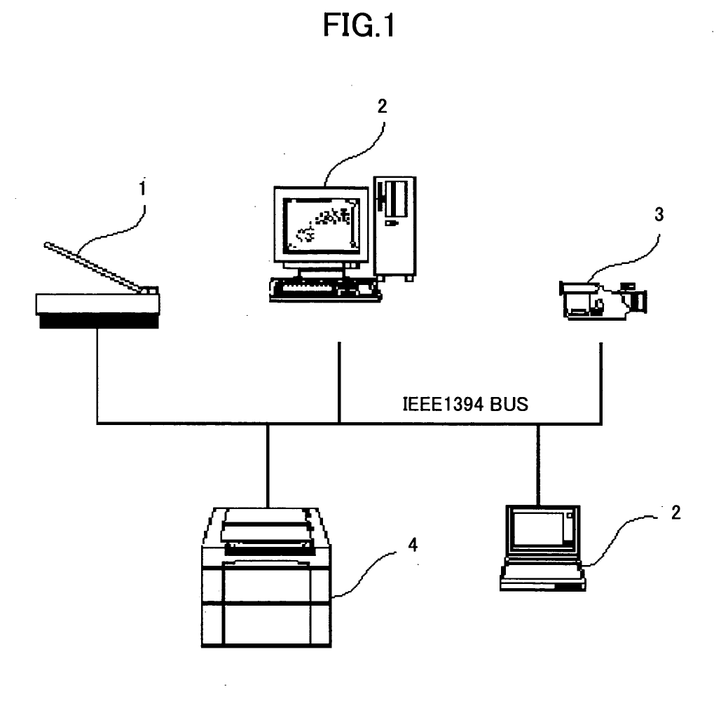

FIG. 1 is a schematic diagram showing a system according to an embodiment of the present invention. The system shown in FIG. 1 includes a scanner 1, personal computers 2, a digital video camera 3, and a multifunction peripheral (MFP) 4 connected via the IEEE 1394 bus.

These apparatuses 1 through 4 connected via the IEEE 1394 bus can exchange data using various protocols such as IEEE 1394-1995, 1394-2000, and Serial Bus Protocol 2 (SBP-2). Especially, SBP-2 is supported by various apparatuses not only the MFP 4 but also storage apparatuses such as hard disk drives (HDD).

The MFP 4 according to an embodiment is a single apparatus that supports multiple functions such as a printer function and a scanner function, for example. When the MFP 4 is connected to the IEEE 1394 bus, the MFP 4 determines whether the printer function and the scanner function, for example, are to be activated, and activates only the function to be activated.

The MFP 4 controls the activating of the functions using two kinds of services (specific computer programs), a control service and function services.

In the following description, it is assumed that the MFP 4 has the printer function and the scanner function that can exchange data with the other apparatuses via the IEEE 1394 SBP-2 bus in which SBP-2print and SBP-2scan are supported as functions, for example. According to another embodiment, the MFP 4 may support other IEEE 1394 protocols such as IP over 1394, SBP-3, and AV/C.

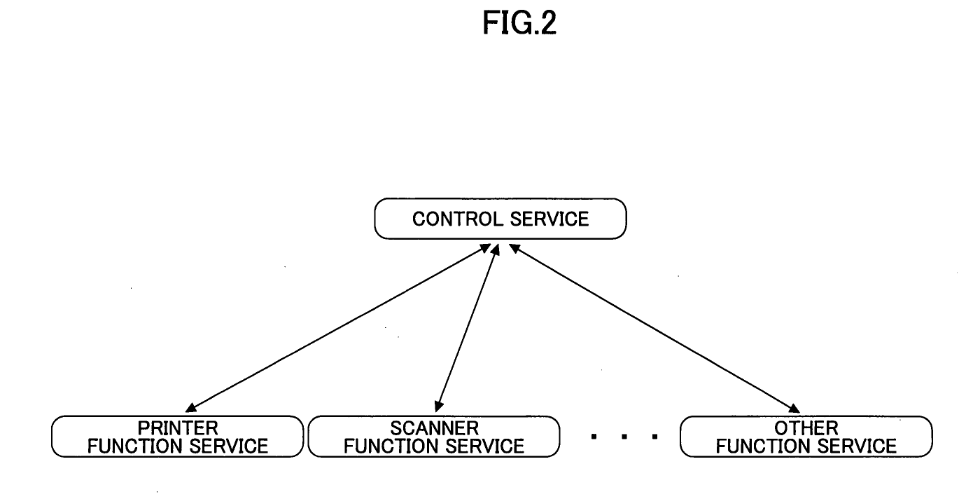

FIG. 2 is a schematic diagram showing the relation among the control service and the function services (printer function service, scanner function service, and other function services).

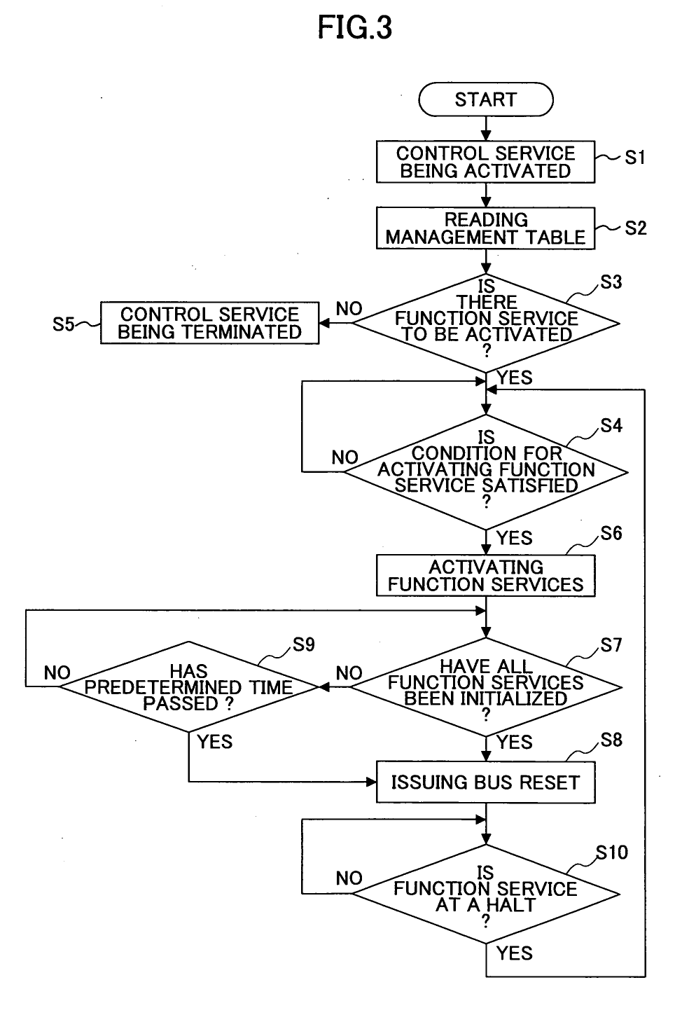

FIG. 3 is a flowchart showing the operation of the control service according to an embodiment. The operation of MFP 4 according to an embodiment is described below with reference to FIGS. 2 and 3.

When the MFP 4 is connected to the IEEE 1394 bus, the control service is activated first (step S1). The control service reads a control table stored in a memory (not shown) of the MFP 4 (step S2).

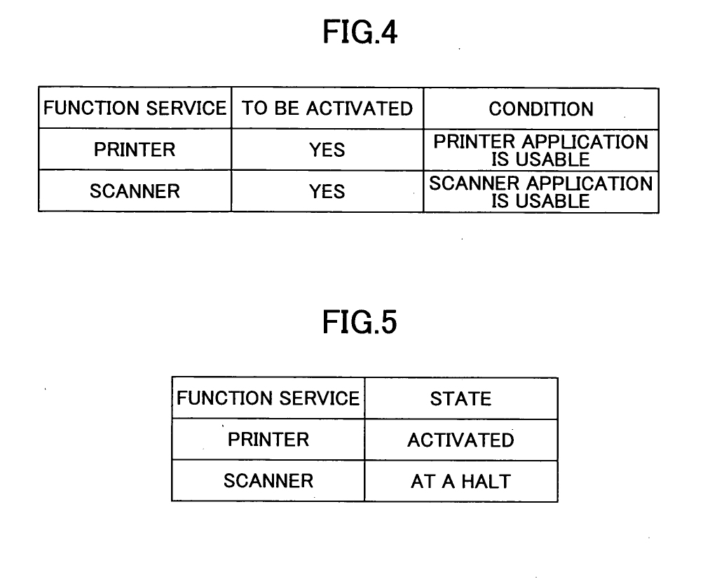

FIG. 4 shows an exemplary control table. The control table indicates whether a function service is to be activated under a specific condition. For example, the control table shown in FIG. 4 indicates that the printer function service is to be activated under a condition that a printer application (the application program that causes the MFP 4 to operate as a printer) of the MFP 4 is usable. Additionally, the control table shown in FIG. 4 indicates that the scanner function service is also to be activated under a condition that a scanner application (the application program that causes the MFP 4 to operate as a scanner) of the MFP 4 is usable.

The control service determines whether there is a function service to be activated by referring to the control table read in step S2 (step S3). If the control service determines that there is a function service to be activated (yes in step S3), the control service further determines whether the condition specified in the control table corresponding to the to-be-activated function service is satisfied (step S4).

If the control service determines that there is no function service to be activated (no in step S3), the control service is terminated (step S5). In the case of the control table shown in FIG. 4, both the printer function service and the scanner function service are to be activated (yes in step S3), and the process proceeds from step S3 to step S4.

If the control service determines that the condition specified in the control table corresponding to the to-be-activated function service is satisfied (yes in step S4), the control service activates the to-be-activated function service (both the printer function service and the scanner function service in this case) (step S6).

The activated function services initialize themselves. The control service determines whether all to-be-activated function services have been initialized (step S7). If the control service determines that all to-be-activated function services have been initialized (yes in step S7), the control service issues a bus reset via the IEEE 1394 bus to notify other apparatuses of the availability of the activated (and initialized) functions of the MFP 4 (step S8).

If the control service determines that not all to-be-activated function services have been initialized (no in step S7), the control service further determines whether a predetermined time has passed since the control service started to activate the to-be-activated function services (step S9).

If the control service determines that the predetermined time has passed (yes in step S9), the control service issues a bus reset via the IEEE 1394 bus to notify other apparatuses of the availability of the activated (and initialized) function of the MFP 4 (step S8). If the control service determines that the predetermined time has not passed yet (no in step S9), the process returns to step S7.

After issuing the bus reset in step S8, the control service determines whether any of the activated (and initialized) function services is at a halt. If the control service determines that a function service is at a halt (yes in step S10), the process returns to step S4. If the control service determines that the function service is not at a halt, the process repeats step S10.

FIG. 5 is an exemplary state control table used by the control service during the operation shown in FIG. 2. The state control table is stored in the memory (not shown) of the MFP 4, and is updated by the control service whenever the state of the function services change. The state control table shown in FIG. 5 indicates that the printer function service is in an activated (and operable) state, and the scanner function service is in a halt state.

If the scanner function of the MFP 4 malfunctions, for example, the scanner function service informs the control service that the scanner function is not usable, and moves to a halt state as shown in the state control table shown in FIG. 5. The control service determines that the scanner function service is at a halt (yes in step S10). The control service leaves the printer function service operating, and if the condition specified in the control table corresponding to the scanner function service is satisfied (yes at step S4), the control service reactivates the scanner function service (step S6).

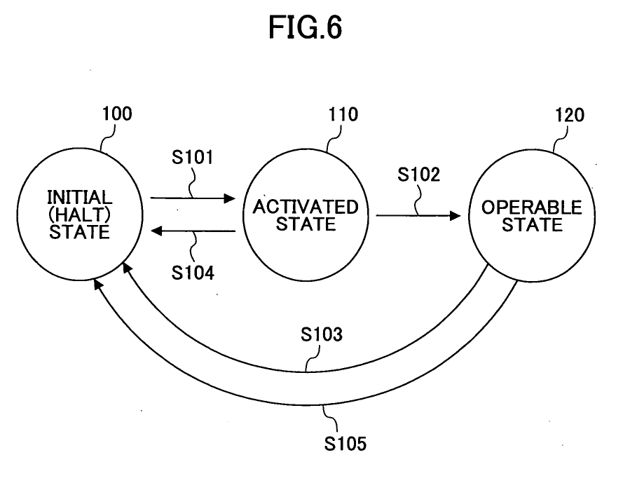

FIG. 6 is a state transition chart for explaining the operation of the function service. Before being activated by the control service, the function service is in an initial state 100. In the initial state 100, the function service is not being executed by the central processing unit (not shown) provided in the MFP 4, and no “process” corresponding to the function service is generated.

When the function service is activated by the control service (step S101), the function service is executed by the central processing unit, and a “process” corresponding to the function service is generated. An activated state 110 denotes the function service has just been activated but is not ready for exchanging data with other apparatuses connected via the IEEE 1394 bus.

The function service initializes itself (step S102), and transits to an operable state 120 in which the function service is ready for exchanging data with the other apparatuses connected via the IEEE 1394 bus.

For example, if the function of the MFP 4 malfunctions, the function service determines that the function of the MFP 4 is not usable, and moves to a halt state (initial state) 100 (step S103).

Additionally, in the case that the control service is terminated by accident, for example, the function service determines that the control service has been terminated, and moves to the halt state 100 (step S105). According to the above arrangements, the MFP 4 can prevent the function service from activating and operating without the control by the control service.

Accordingly, multiple functions provided in the function control apparatus according to an embodiment can be efficiently controlled. The function control apparatus according to an embodiment can prevent the function service from being activated, and use its resource such as memory space and processing time effectively.

Additionally, if the function service is terminated due to the malfunction of the system, the control service can reactivate the function service. To the contrary, if the control service is terminated by accident, for example, the function service is terminated and is prevented from operating without the control of the control service.

Furthermore, multiple function services can be activated and initialized without issuing the bus reset every time one function service is activated and initialized. According to the arrangement, the function control apparatus can prevent the IEEE 1394 bus from becoming unstable due to the issuing of many bus resets.

The present invention is not limited to the multifunction peripherals. According to another embodiment, a function control apparatus according to the present invention may be any apparatus supporting multiple functions that can exchange data via the IEEE 1394 bus.

The preferred embodiments of the present invention are described above. The present invention is not limited to these embodiments, but variations and modifications may be made without departing from the scope of the present invention.

This patent application is based on Japanese Priority Patent Application No. 2003-126414 filed on May 1, 2003, the entire contents of which are hereby incorporated by reference.

What is claimed is:

1. A function control apparatus, comprising:
a plurality of function service units configured to operate in response to receipt of a signal from another apparatus via an IEEE 1394 bus;
a control service unit configured to identify one or more of the function service units to be activated, to activate the identified function service unit, and to stop the activated identified function service unit.

2. The function control apparatus as claimed in claim 1, wherein
the control service unit transmits a bus reset signal to the other apparatus via the IEEE 1394 bus, the bus reset signal notifying the other apparatus that the identified function service unit is in an operable state, at a point of time determined based on the number of the identified function service units.

3. The function control apparatus as claimed in claim 2, wherein
the control service unit, when all of the identified function service units are in the operable state, transmits the bus reset signal to the other apparatus.

4. The function control apparatus as claimed in claim 2, wherein
the control service unit, even when not all of the identified function service units are in the operable state, if a predetermined period of time has passed, transmits the bus reset signal to the other apparatus.

5. The function control apparatus as claimed in claim 1, wherein
if the control service unit determines that no function service unit is to be activated, the control service unit stops.

6. The function control apparatus as claimed in claim 1, wherein
the function control apparatus is a multifunction peripheral that functions as a printer and a scanner.

7. The function control apparatus as claimed in claim 1, wherein
when a function module fails, one of the function service units corresponding to the failed function module informs the control service unit of the failure of the function module.

8. The function control apparatus as claimed in claim 7, wherein
when the function module fails, the one of the function service units corresponding to the failed function module stops after the informing of the failure of the function module.

9. The function control apparatus as claimed in claim 8, wherein
the control service unit monitors the failed function module, and if the failed function module recovers, the control service unit reactivates the one of the function service units corresponding to the recovered function module.

10. The function control apparatus as claimed in claim 1, wherein
when the control service unit stops, the control service unit informs the function service units of the stopping.

11. The function control apparatus as claimed in claim 10, wherein
the function service units stop in response to the information from the control service unit that the control service unit is stopping.

12. A method of controlling a plurality of function services, comprising the steps of:
identifying one or more of the function services to be activated in response to receipt of a signal from another apparatus via an IEEE 1394 bus;
activating the identified function service; and
stopping the activated identified function service.

13. A computer program that causes a computer to perform a method of controlling a plurality of function services, the method comprising the steps of:
identifying one or more of the function services to be activated in response to receipt of a signal from another apparatus via an IEEE 1394 bus;
activating the identified function service; and
stopping the activated identified function service.
